(19) United States
(12) Patent Application Publication
(10) Pub. No.: US 2023/0274926 A1
(43) Pub. Date: Aug. 31, 2023

(54) HEATER FOR IONIZATION

(71) Applicant: SHIMADZU CORPORATION, Kyoto-shi (JP)

(72) Inventor: Yoshimi HASHIGUCHI, Kyoto-shi (JP)

(73) Assignee: SHIMADZU CORPORATION, Kyoto-shi (JP)

(21) Appl. No.: 18/169,540

(22) Filed: Feb. 15, 2023

(30) Foreign Application Priority Data
Feb. 25, 2022 (JP) 2022-028503

(51) Int. Cl. H01J 49/16; H01J 49/24

(52) U.S. Cl. CPC H01J 49/165; H01J 49/24

(57) ABSTRACT

A heater for ionization is used to produce ions from a sample. The heater for ionization has a bobbin, an electric heating wire and an electrode. The bobbin extends in one direction. The electric heating wire is wound around the bobbin. The electrode is welded to the electric heating wire. In the bobbin, a groove portion extending in the one direction is formed. The electrode is fitted into the groove portion.

### BACKGROUND

### Technical Field

The present invention relates to a heater for ionization.

### Description of Related Art

An ionization device that produces ions from a sample to be analyzed is provided in a mass spectrometer. For example, JP 2021-089227 A describes a mass spectrometer provided with a heater and an ionization probe. An assist gas heated by the heater is supplied to a liquid sample sprayed from the ionization probe, so that an organic solvent of the liquid sample is vaporized. This improves ionization efficiency of the liquid sample.

### SUMMARY

As the size of mass spectrometers is reduced in recent years, it is required that the size of the ionization devices is to be reduced. In this case, it is also necessary to reduce the size of heaters for ionization. However, it has been found that, when the size of a heater is reduced, the connection portion between an electric heating wire and an electrode for supplying a voltage is likely to break. Thus, reliability is degraded.

An object of the present invention is to provide a heater for ionization a size of which can be reduced without degradation of reliability.

One aspect of the present invention relates to a heater for ionization that is used for ionization of a sample, and has a bobbin that extends in one direction, an electric heating wire that is wound around the bobbin, and an electrode welded to the electric heating wire, wherein a groove portion extending in the one direction is formed in the bobbin, and the electrode is fitted into the groove portion.

With the present invention, it is possible to reduce the size of a heater for ionization without degradation of reliability.

Other features, elements, characteristics, and advantages of the present disclosure will become more apparent from the following description of preferred embodiments of the present disclosure with reference to the attached drawings.

### BRIEF DESCRIPTION OF THE DRAWING

FIG. 1 is a diagram showing the configuration of a mass spectrometer including a heater according to one embodiment of the present invention;

FIG. 2 is a schematic perspective view showing the configuration of the heater;

FIG. 3 is a plan view of the heater of FIG. 2;

FIG. 4 is a plan view showing the configuration of a leaf spring; and

FIG. 5 is a side view showing the configuration of the leaf spring.

### DETAILED DESCRIPTION

### (1) Mass Spectrometer

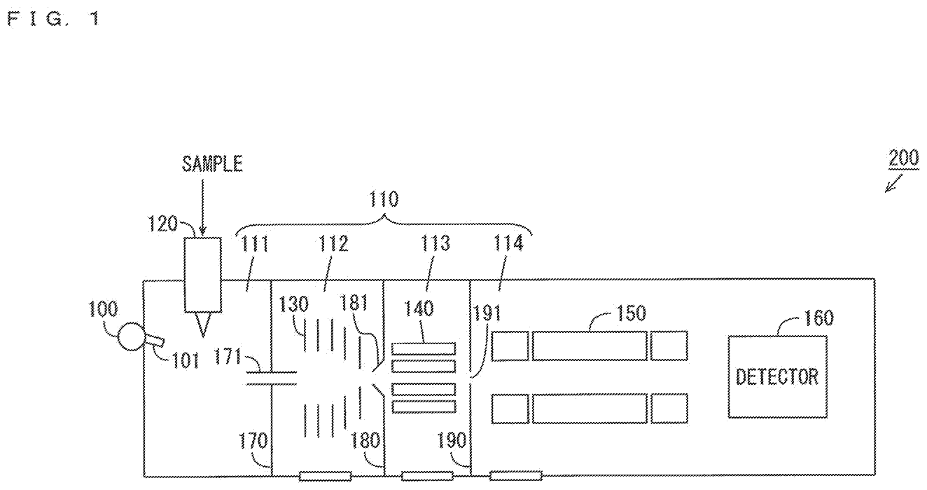

A heater for ionization (hereinafter simply referred to as a heater) according to embodiments of the present invention will be described below in detail with reference to the drawings. FIG. 1 is a diagram showing the configuration of a mass spectrometer including a heater according to one embodiment of the present invention. As shown in FIG. 1, the mass spectrometer 200 includes the heater 100, a vacuum container 110, an ionization device 120, ion guides 130,140, a mass filter 150 and a detector 160.

In the vacuum container 110, an ionization chamber 111, a vacuum chamber 112, a vacuum chamber 113 and a vacuum chamber 114 are arranged in this order from an upstream position to a downstream position. A degree of vacuum in the vacuum container 110 increases from an upstream position to a downstream position. Therefore, the ionization chamber 111 has the lowest degree of vacuum, and the vacuum chamber 114 has the highest degree of vacuum. For example, the pressure in the ionization chamber 111 is an approximately atmospheric pressure, and the pressure in the vacuum chamber 114 is 10-2 to 10-3 Pa.

The ionization chamber 111 and the vacuum chamber 112 are partitioned by a partition wall 170. A desolvation line 171 is provided in the partition wall 170. The vacuum chamber 112 and the vacuum chamber 113 are partitioned by a partition wall 180. A skimmer cone 181 is provided in the partition wall 180. The vacuum chamber 113 and the vacuum chamber 114 are partitioned by a partition wall 190. A hole 191 is provided in the partition wall 190.

The ionization device 120 is an ionization probe such as an ESI (Electrospray Ionization) probe. The ionization device 120 is attached to the ionization chamber 111. A liquid sample is introduced into the ionization device 120 from a liquid chromatograph or the like. Further, a nebulizer gas such as a nitrogen gas is introduced into the ionization device 120. The ionization device 120 uses a nebulizer gas to spray a sample into the ionization chamber 111 while applying an electric charge to the sample.

The heater 100 is attached to the ionization chamber 111. A heating gas such as clean air is introduced into the heater 100. The heater 100 supplies the heating gas from the nozzle 101 to the sample while heating the heating gas. Thus, desolvation of the sprayed sample is promoted, and components in the sample are ionized in the ionization chamber 111. Normally, monovalent ions of each component are produced. Details of the heater 100 will be described below.

The ion guides 130, 140 are arranged in the vacuum chambers 112, 113, respectively. Ions produced in the ionization chamber 111 are guided to the vacuum chamber 112 through the desolvation line 171 of the partition wall 170. The ions that have reached the vacuum chamber 112 are guided to the vacuum chamber 113 through the skimmer cone 181 of the partition wall 180 by the ion guide 130. The ions that have reached the vacuum chamber 113 are guided to the vacuum chamber 114 through the hole 191 of the partition wall 190 by the ion guide 140.

The mass filter 150 is a quadrupole mass filter including four rod electrodes, for example, and is arranged in the vacuum chamber 114. The mass filter 150 causes only ions having a specific mass-to-charge ratio corresponding to a voltage applied to the rod electrodes among the ions that have reached the vacuum chamber 114 to fly and pass. The detector 160 is an electron multiplier tube, for example, and is arranged in the vacuum chamber 114 so as to be located at a position farther downstream than the mass filter 150. The detector 160 detects the ions that have passed through the mass filter 150. A result of ion detection is used to produce a mass spectrum, for example.

### (2) Heater

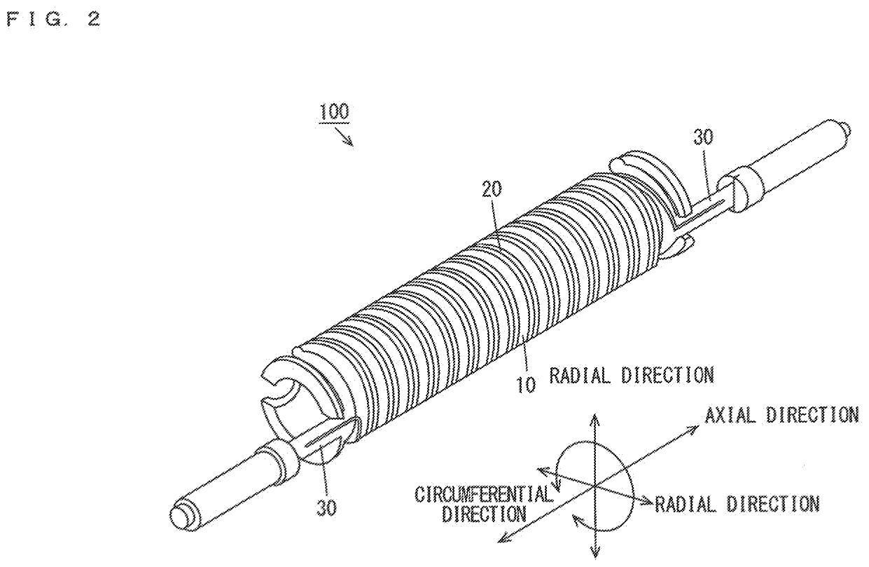

FIG. 2 is a schematic perspective view showing the configuration of the heater 100. As shown in FIG. 2, the heater 100 includes a bobbin 10, an electric heating wire and a pair of electrodes 30. The bobbin 10 is a cylindrical member extending in one direction, and has a substantially cylindrical shape in the present example. In the following description, in the heater 100, the direction in which the bobbin 10 extends is referred to as an axial direction, and the direction orthogonal to the axial direction is referred to as a radial direction. Further, in the cross section orthogonal to the axial direction, the direction extending along the outer circumferential surface of the bobbin 10 is referred to as a circumferential direction.

The bobbin 10 is formed of a material having heat resistance and an insulating property. The bobbin 10 is preferably resistant to heat equal to or higher than 1000° C. In the present example, the bobbin 10 is formed of ceramic. The electric heating wire is wound around the outer peripheral surface of the bobbin 10. The electric heating wire 20 is preferably formed of a material having a high heat generating property. In the present example, the electric heating wire 20 is a nichrome wire. The both end portions of the electric heating wire 20 are respectively and electrically connected to the pair of electrodes 30.

The pair of electrodes 30 is respectively attached to the both end portions of the bobbin 10 and is drawn respectively and outwardly in the axial direction from the both end portions of the bobbin 10. Further, a voltage is supplied from the power supply to the pair of electrodes 30, so that the heater 100 is operated. Thus, an introduced heating gas is heated.

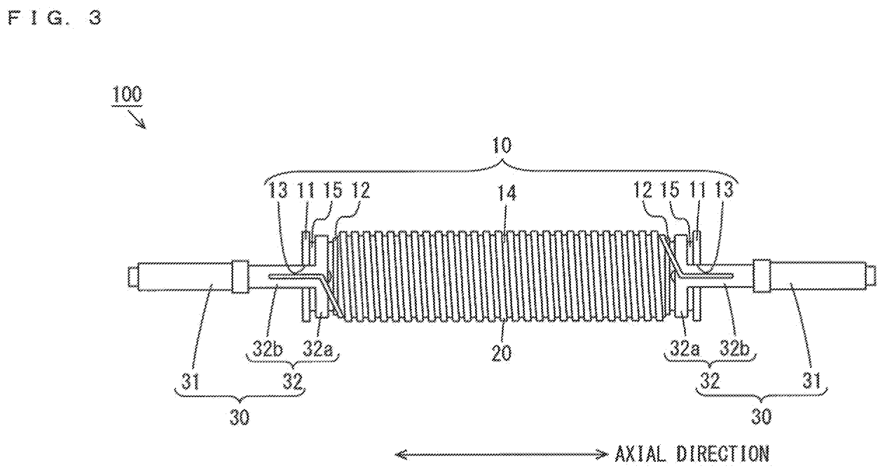

FIG. 3 is a plan view of the heater 100 of FIG. 2. As shown in FIG. 3, the bobbin has a pair of flanges 11 and a pair of flanges 12. Each of the flanges 11, 12 has a circular outer edge. Each flange 11 is an example of a first flange. Each flange 12 is an example of a second flange.

The pair of flanges 11 surrounds the outer circumferential surfaces of the both end portions of the bobbin 10. A groove portion 13 extending in the axial direction is formed in each flange 11. One flange 12 surrounds the outer peripheral surface of a portion of the bobbin 10 which is spaced apart from one end portion of the bobbin 10 by a predetermined distance in the axial direction. The other flange 12 surrounds the outer peripheral surface of a portion of the bobbin 10 which is spaced apart from the other end portion of the bobbin 10 by a predetermined distance in the axial direction.

A winding area 14 having a cylindrical shape is provided between the pair of flanges 12 in the bobbin 10. The electric heating wire 20 is wound around the winding area 14. While the diameter of the winding area 14 is larger than the diameter of each flange 12 in the present example, the embodiment is not limited to this. The diameter of the winding area 14 may be smaller than the diameter of the flange 12 or may be equal to the diameter of the flange 12. An electrode area 15 having a cylindrical shape is provided between the flanges 11, 12 at each end portion of the bobbin 10. The diameter of each electrode area 15 is smaller than the diameter of the flange 11 and the diameter of the flange 12.

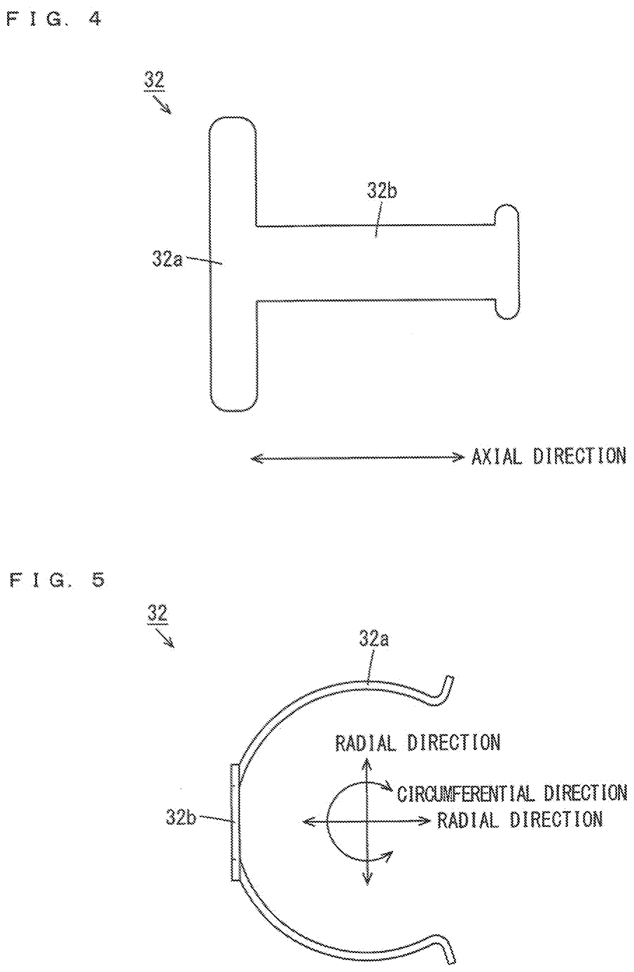

Each electrode 30 includes a connection terminal 31 and a leaf spring 32. Although the configuration of one electrode 30 will be described below, the configuration of the other electrode 30 is similar. The connection terminal 31 has a pin shape extending in the axial direction. FIG. 4 is a plan view showing the configuration of the leaf spring 32. FIG. 5 is a side view showing the configuration of the leaf spring 32. As shown in FIGS. 4 and 5, the leaf spring 32 includes a holding portion 32a and a projecting portion 32b.

The holding portion 32a is a curved member having a C-shaped cross section. In the axial direction, the width of the holding portion 32a is smaller than the width of the electrode area 15 (the distance between the flanges 11, 12) of the bobbin 10 of FIG. 3. The inner diameter (diameter of curvature) of the holding portion 32a is slightly larger than the outer diameter of the electrode area 15. While the both end portions of the holding portion 32a are folded outwardly in the radial direction after extending in the peripheral direction in the example of FIG. 5, the embodiment is not limited to this.

The projecting portion 32b has a substantially flat plate shape and projects in the axial direction from a substantially central portion of the end surface of the holding portion 32a. In the circumferential direction, the width of the projecting portion 32b is slightly smaller than the width of the groove portion 13 of the flange 11 of FIG. 3. While the tip of the projecting portion 32b is formed wide in the example of FIG. 4, the embodiment is not limited to this.

The projecting portion 32b is fitted into the groove portion 13 of the flange 11. In this state, the holding portion 32a holds the electrode area 15 so as to abut against the electrode area 15 of the bobbin 10. Thus, the leaf spring 32 is attached to the end portion of the bobbin 10. An end portion of the electric heating wire 20 is connected to the outer peripheral surfaces of the holding portion 32a and the projecting portion 32b by welding. In the present example, the electric heating wire 20 is in contact with the bobbin 10 without floating in the air except for a portion that is in contact with the leaf spring 32. The tip of the projecting portions 32b is connected to the proximal end of the connection terminal 31 by welding. The tip of the connection terminal 31 is connected to the power supply for supplying a voltage through a cable (not shown).

### (3) Effects

In the heater 100 according to the present embodiment, the electrode 30 is connected to the electric heating wire 20 by welding. Therefore, unlike a case in which the electrode 30 is connected to the electric heating wire 20 by a screw or the like, no torsion occurs in the connection portion between the electric heating wire 20 and the electrode 30.

Further, because the electrode 30 is fitted into the groove portion 13 extending in the axial direction of the bobbin 10, the electrode 30 has a degree of freedom to be slidable in the axial direction. This reduces the mechanical tension applied in the axial direction to the connection portion between the electric heating wire 20 and the electrode 30. Therefore, even in a case in which the size of the heater 100 is small, the possibility of breakage of the connection portion between the electric heating wire 20 and the electrode 30 is reduced. As a result, it is possible to reduce the size of the heater 100 without degrading reliability.

Further, the electrode 30 includes the leaf spring 32 attached to the bobbin 10. In this case, the leaf spring 32 has a degree of freedom to be deformable in the radial direction. This reduces the mechanical tension applied in the radial direction to the connection portion between the electric heating wire 20 and the electrode 30. Therefore, the possibility of breakage of the connection portion between the electric heating wire 20 and the electrode 30 is further reduced. As a result, it is possible to reduce the size of the heater 100 while further improving reliability.

Here, the leaf spring 32 includes the holding portion 32a that holds the bobbin and the projecting portion 32b that projects in the axial direction from the holding portion 32a and is fitted into the groove portion 13. The bobbin 10 has a cylindrical shape, and the cross section of the holding portion 32a has a C shape that abuts against the outer peripheral surface of the bobbin 10. In this case, the electrode 30 can be easily attached to the bobbin 10 while being fitted into the groove portion 13.

The electric heating wire 20 is in contact with the bobbin 10 without floating in the air except for the portion that is in contact with the electrode 30. In this case, because a decrease in temperature in a local area of the electric heating wire 20 is suppressed, the temperature distribution of the electric heating wire 20 can be made close to being uniform. Therefore, thermal tension is prevented from being applied to the connection portion between the electric heating wire 20 and the electrode 30. Thus, the possibility of breakage of the connection portion between the electric heating wire 20 and the electrode 30 is further reduced. As a result, it is possible to reduce the size of the heater 100 while further improving reliability.

The flange 11 is formed at the end portion of the bobbin 10, and the groove portion 13 is formed in the flange 11. In this case, the electrode 30 is prevented from falling off from the end portion of the bobbin 10 by the first flange 11. Thus, the electrode can be attached to the bobbin 10 stably.

Further, the flange 12 is formed at the portion which is spaced apart from the end portion of the bobbin 10 by a predetermined distance in the axial direction, and the electrode 30 is attached to the electrode area 15 between the flange 11 and the flange 12 while being fitted into the groove portion 13 of the flange 11. In this case, the sliding range of the electrode 30 is restricted by the flange 11 and the flange 12. Thus, the electrode 30 can be attached to the bobbin 10 more stably.

### (4) Other Embodiments

(a) While the electrode 30 includes the connection terminal 31 in the above-mentioned embodiment, the embodiment is not limited to this. The electrode 30 does not have to include the connection terminal 31. In this case, a cable extending from the power supply may be connected to the leaf spring 32 by welding or the like.

(b) While the flange 12 is formed in the bobbin 10 in the above-mentioned embodiment, the embodiment is not limited to this. The flange 12 does not have to be formed in the bobbin 10. While the flange 11 is also formed in the bobbin 10, the embodiment is not limited to this. The flange 11 does not have to be formed in the bobbin 10. In this case, the groove portion 13 may be formed in the outer peripheral surface of the bobbin 10.

(c) As described by way of example in the above-mentioned embodiment, it is preferable that the groove portions 13 are formed in the both end portions of the bobbin 10, and the pair of electrodes 30 is respectively fitted into the groove portions 13 at the both end portions of the bobbin 10. However, the embodiment is not limited to this. The groove portion 13 may be formed only in one end portion of the bobbin 10, and only one electrode 30 may be fitted into the groove portion 13 of the bobbin 10.

(d) While the pair of electrodes 30 is drawn outwardly in the axial direction from the both end portions of the bobbin 10 in the above-mentioned embodiment, the embodiment is not limited to this. The pair of electrodes 30 may be drawn outwardly in the axial direction from one end portion of the bobbin 10.

### (5) Aspects

It is understood by those skilled in the art that the plurality of above-mentioned illustrative embodiments are specific examples of the below-mentioned aspects.

(Item 1) A heater for ionization according to one aspect that is used for ionization of a sample, may have a bobbin that extends in one direction, an electric heating wire that is wound around the bobbin, and an electrode welded to the electric heating wire, wherein a groove portion extending in the one direction may be formed in the bobbin, and the electrode may be fitted into the groove portion.

In this heater for ionization, the electrode is connected to the electric heating wire by welding. Therefore, unlike a case in which an electrode is connected to an electric heating wire by a screw or the like, no torsion occurs at the connection portion between the electric heating wire and the electrode. Further, because being fitted into the groove portion extending in the one direction of the bobbin, the electrode has a degree of freedom to be slidable in the axial direction parallel to the one direction. This reduces the mechanical tension applied in the axial direction to the connection portion between the electric heating wire and the electrode. Therefore, even in a case in which the size of the heater for ionization is small, the possibility of breakage of the connection portion between the electric heating wire and the electrode is reduced. As a result, it is possible to reduce the size of the heater for ionization without degrading reliability.

(Item 2) The heater for ionization according to item 1, wherein the electrode may include a leaf spring attached to the bobbin.

In this case, the leaf spring has a degree of freedom to be deformable in the radial direction that intersects with the one direction. This reduces the mechanical tension applied in the radial direction to the connection portion between the electric heating wire and the electrode. Therefore, the possibility of breakage of the connection portion between the electric heating wire and the electrode is further reduced. As a result, it is possible to reduce the size of the heater for ionization while improving reliability.

(Item 3) The heater for ionization according to item 2, wherein the leaf spring may include a holding portion that holds the bobbin, and a projecting portion that projects in the one direction from the holding portion and is fitted into the groove portion.

In this case, the electrode can be attached to the bobbin while being fitted into the groove portion.

(Item 4) The heater for ionization according to item 3, wherein the bobbin may have a cylindrical shape, and a cross section of the holding portion may have a C-shape that abuts against an outer peripheral surface of the bobbin.

In this case, the electrode can be attached to the bobbin more easily.

(Item 5) The heater for ionization according to any one of items 1 to 4, wherein the electric heating wire may be in contact with the bobbin without floating in air except for a portion that is in contact with the electrode.

In this case, because a decrease in temperature in a local area of the electric heating wire is suppressed, the temperature distribution of the electric heating wire can be made close to being uniform. Therefore, thermal tension is prevented from being applied to the connection portion between the electric heating wire and the electrode. Thus, the possibility of breakage of the connection portion between the electric heating wire and the electrode is further reduced. As a result, it is possible to reduce the size of the heater for ionization while further improving reliability.

(Item 6) The heater for ionization according to any one of items 1 to 5, wherein a first flange may be formed at an end portion of the bobbin, and the groove portion may be formed in the first flange.

In this case, the electrode is prevented from falling off from the end portion of the bobbin by the first flange. Thus, the electrode can be attached to the bobbin stably.

(Item 7) The heater for ionization according to item 6, wherein a second flange may be formed at a portion that is spaced apart from the end portion of the bobbin by a predetermined distance in the one direction, and the electrode may be attached to an area between the first flange and the second flange while being fitted into the groove portion of the first flange.

In this case, the sliding range of the electrode is restricted by the first flange and the second flange. Thus, the electrode can be attached to the bobbin more stably.

While preferred embodiments of the present disclosure have been described above, it is to be understood that variations and modifications will be apparent to those skilled in the art without departing the scope and spirit of the present disclosure. The scope of the present disclosure, therefore, is to be determined solely by the following claims.

I/We claim:

1. A heater for ionization that is used for ionization of a sample, having:
a bobbin that extends in one direction;
an electric heating wire that is wound around the bobbin; and
an electrode welded to the electric heating wire, wherein
a groove portion extending in the one direction is formed in the bobbin, and
the electrode is fitted into the groove portion.

2. The heater for ionization according to claim 1, wherein
the electrode includes a leaf spring attached to the bobbin.

3. The heater for ionization according to claim 2, wherein
the leaf spring includes
a holding portion that holds the bobbin, and
a projecting portion that projects in the one direction from the holding portion and is fitted into the groove portion.

4. The heater for ionization according to claim 3, wherein
the bobbin has a cylindrical shape, and
a cross section of the holding portion has a C-shape that abuts against an outer peripheral surface of the bobbin.

5. The heater for ionization according to claim 1, wherein
the electric heating wire is in contact with the bobbin without floating in air except for a portion that is in contact with the electrode.

6. The heater for ionization according to claim 1, wherein
a first flange is formed at an end portion of the bobbin, and
the groove portion is formed in the first flange.

7. The heater for ionization according to claim 6, wherein
a second flange is formed at a portion that is spaced apart from the end portion of the bobbin by a predetermined distance in the one direction, and
the electrode is attached to an area between the first flange and the second flange while being fitted into the groove portion of the first flange.
